(19) United States
(12) Patent Application Publication
(10) Pub. No.: US 2021/0245159 A1
(43) Pub. Date: Aug. 12, 2021

(54) Massively Parallel Rapid Single Cell Reader and Sorter

(71) Applicant: Daniel Zimarev, Vilnius (LT)

(72) Inventor: Daniel Zimarev, Vilnius (LT)

(73) Assignee: Design Depository Ltd, Victoria (SC)

(21) Appl. No.: 17/158,031

(22) Filed: Jan. 26, 2021

(30) Foreign Application Priority Data
Jan. 27, 2020 (LT) 2020006

(51) Int. Cl. B01L 3/00

(52) U.S. Cl. CPC B01L 3/502761; B01L 2300/1822; B01L 2300/0883; B01L 2200/0652

(57) ABSTRACT

Current state of the art in microfluidic pumping, single cell labelling, mixing, emulsification, incubation, optical excitation, reading and sorting component technology is presented. This is followed by the description of the invention, that fuses these components into a single system, available in four configurations, characterised by three structural and functional innovations. The first unique feature is intra and inter parallel architecture enabling fast, high-throughput, flexible and scalable single cell reading and sorting. Second—dual, laser-enabled detection of information, both fluorescent-genetic and visual-morphological; and its combination and processing using machine learning algorithms. Third—novel mixing, incubation and reading-sorting component structure.

### FIELD OF THE INVENTION

Literature contains information on low-throughput cell sorting systems. There is also information on individual components: (P) pumps, (E) cell and fluorescent marker microfluidic emulsifiers, and (R) technology for digital laser spectroscopy and cell sorting. However, there seems to be no precedent for an integrated massively intra and inter parallel microfluidic, machine learning driven single cell reading and sorting system.

P) U.S. Pat. Nos. 7,842,248B2, 7,842,248B2, EP1150013A2 describe microfluidic pumps. They are suitable for low hydraulic resistance serial systems; however, are unsuitable for single entry massively parallel, high throughput, high hydraulic resistance systems.

E) Labelling cell genetic code is a standard procedure. CN102344494B describes a fluorescent system for detecting gene encoding nicotinamide adenine dinucleotide (NAD). U.S. Pat. No. 9,1334,99 B2 describes union of three microfluidic channels (dedicated to cells, markers and wash) used for fluorescent marking. U.S. Pat. No. 9,689,024 B2 describes DNA marking in microwells. U.S. Pat. No. 6,608,189 B1 uses green fluorescent protein dye to optically measure pH levels across the cell. US20150154352A1 talks about bead use in DNA/RNA encoding. AU2011295722A1 discusses DNA/RNA strand dyeing with the aim of identifying malignant and healthy cells via spectroscopy.

Creating emulsions (including cell-in-droplet ones) using microfluidics is also a standard, albeit relatively new, technique. US20100018584A1 and JP2009536313A use classic “+” and “T” shaped microfluidic junctions for water-in-oil droplet generation. CN104321652A describes a tri-layered stream ABA: a laser beam causes cavitation in layer A, which in turns pushes droplets out of B into the third layer A. WO2014151658A1 describes a similar concept, however in a bi-layer stream. WO2015164212A1 talks about cell genetic information labelling and droplet encapsulation. US20140113347A1 presents biopolymer use in cell encapsulation.

A problem evident in cell gene labelling and encapsulation architectures is low throughput caused by the use of a single serial channel. CA2484336C describes the use of four different fluorescent dyes to target the four DNA bases (A, C, G and T), which can subsequently be distinguished by the optical sensor following Argon laser activation of the dyed genetic material; eventually allowing to build-up the genomic library.

R) EP3409791A1 and U.S. Pat. No. 5,595,900A discuss gene sequence library preparation. These libraries can be instrumental in cell identification. U.S. Pat. No. 7,214,298B2 presents a simple single microfluidic chip, two-channel, laser induced fluorescence based cell sorter. US20110065143 uses laser induced fluorescence for reading stem cells, regenerative medicine applications. U.S. Pat. No. 8,936,762B2 discusses microfluidic, visual-morphological laser-based cell reading. Finally, U.S. Pat. No. 9,186 643B2 talks about microfuidic cell sorting for in vitro evolution.

### SUMMARY OF THE INVENTION

The first distinguishing feature of the device is highly intra and inter parallelised modular architecture. It enables rapid reading and sorting of cells—a crucial aspect for successfully commercialising microfluidic sorting technology.

Pharmaceutical antibody engineering and selection is one of the application areas of the device. Analogous to the growth of No of transistors/area in electrical engineering, there has been growth in the No of antibody tests/unit of time in biomedical engineering. In the 90s it was possible to do 10³ tests/week. The advent of robotics increased this No to ≈10⁷. This highly parallelised microfluidic approach opens the door for further increase.

The use of microfluidics also reduces the amount of reagents and sample needed; in a clinical setting this means—less blood taken.

Traditional fluorescence activated cell sorters contain a nozzle that can emit hazardous aerosols. This device uses an alternative, safer, microfluidic droplet generation process.

Below individual modules and their configurations are described: (P) pumping, (E) emulsification, (I) incubation and (R) reading and sorting.

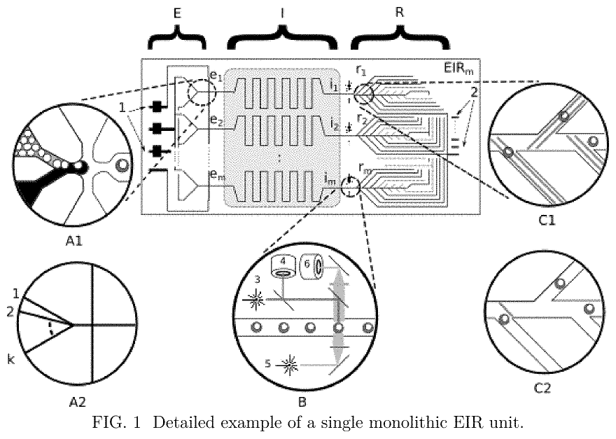

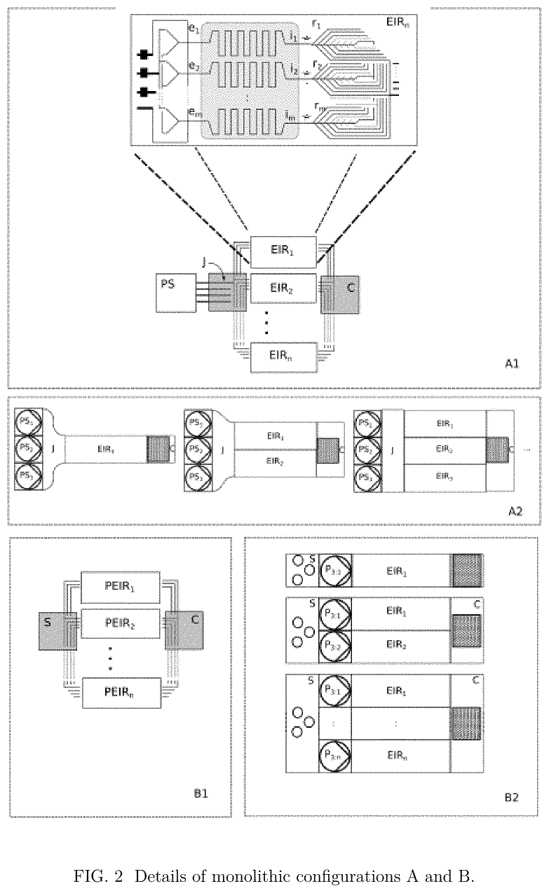

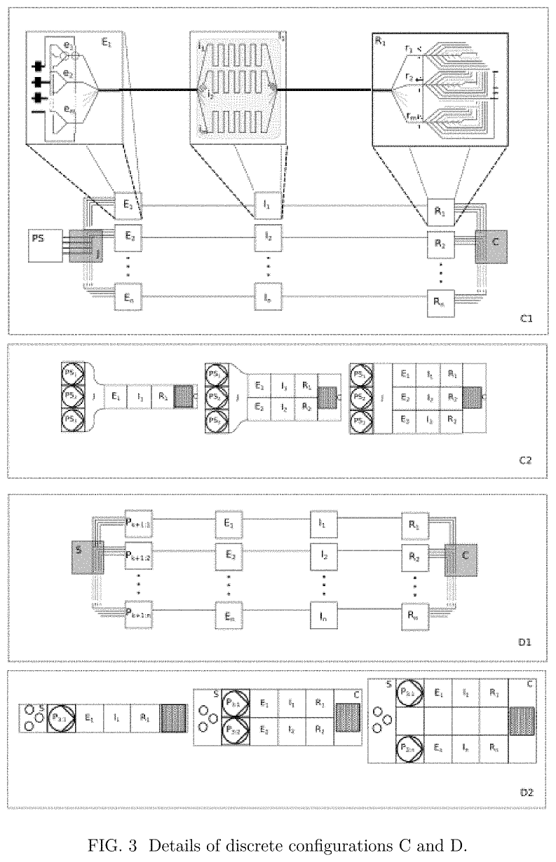

P) There are two types of pumping modules: Pₖ₊₁ ir P_{k+1:n}. Different configurations of the device require different pumps. Pₖ₊₁ (also labelled as PSₖ₊₁ to emphasize presence of the sample) is used in conf. A (FIG. 2) and C (FIG. 3), whereas P_{k+1:n} in B (FIG. 2) and D (FIG. 3). k indicates the sample streams, either cell or reagent, No, which eventually mix together in the emulsification component (see FIG. 1, details A1 and A2); each stream requires an individual pump. “+1” reflects the fact that (at the downstream “+” shaped junction) a constant oil stream is necessary to separate cells into individual droplets, i.e. an extra pump is required. The minimum number of pumps is three, but depending on the cell labelling protocol, number of markers, amplification protocol and the use of wash buffer it can be four, five or more. P_{k+1:n} module is of (k+1)-in-one type; this means a single module has k+1 required pumps. n denotes the module inter-parallelisation sequence number; there is no upper limit to it—the higher the throughput requirement, the more modules are parallelised. m is the intra-parallelisation No. Type Pₖ₊₁ pumps are more powerful, as they have to work against higher hydraulic resistance of the whole system (with multiple parallel modules). Type P_{k+1:n} pumps are less powerful as they only need to overcome hydraulic resistance of a single module. Pₖ₊₁ is a standalone single-syringe (single-sample) or two-syringe (for continuous flow) pump component. To save space pump P_{k+1:n} has the option to be based on k+1 peristaltic, electroosmotic, pulse or centrifuge units (see FIG. 2, detail B1). Low pressure requirement also allows for the use of microfluidic pumping units.

Drawings also use letters S—denoting the sample (in configurations B and D) and J—denoting junction (config. A and C).

E) Eₙ denotes the emulsification module, which consists of smaller eₘ functional units. FIG. 1, detail 1 shows input channels with optional microfluidic filters. In its simplest form it contains three inlet channels and one outlet. Two meet at the initial junction, where one channel is carrying cells, whilst the other—fluorescent in situ sequencing (FISSEQ) reagent mix. The mixture then travels downstream to the second junction, where it meets oil from the third inlet, which separates out single-cell droplets; this process is illustrated in FIG. 1, detail A1. The outlet is used to dispose of oil once it passes the 2nd junction. This architecture is scalable—FIG. 1, detail A2, shows how k inlets can be added.

I) Droplets then travel along m serpentine channels of the incubation module Iₙ. This geometry induces mixing and allows incubation time control. A Peltier plate adds further—thermoelectric—reaction control.

R) In the reading and sorting module Rₙ continuous wave laser (FIG. 1, detail B, mark 3) activates fluorescent mitochondrial cytochrome oxidase subunit 1 (COI) gene dye. This activated dye in turn emits a signature-length electromagnetic wave, which is caught and measured by the optical sensor (FIG. 1, detail B, mark 4). Collected information reflects a unique sequence of repeating A,C,G and T bases. The data processing unit (DPU) checks this sequence against a genomic library; the process is aided by a machine learning classification algorithm. Titanium-sapphire pulsed laser (FIG. 1, detail B, mark 5) generated, and further modified, wave passes the cell, capturing its unique visual-morphological footprint. This information hits another sensor (FIG. 1, detail B, mark 6) and is passed on to DPU for processing by machine vision and deep neural network algorithms.

The user has the option to pre-set cell types he would like to capture. He also has a free-style setting, where the system scans and collects information about potentially thousands of cell types present in the sample; the DPU then clusters them by similarity into categories. Here, depending on user settings, the DPU utilises another family of machine learning algorithms: k-means and hierarchical clustering. A noteworthy setting is sorting cells by similarity into up to 98 categories; this matches the No of wells in a standard microplate. This paves the way for precision genomic library creation; or physical sorting of cells without the need to pre-define categories—automatically; according to feature similarity.

These three pillars: (i) fluorescent-genetic information collection, (ii) visual-morphological information collection and (iii) processing of said information in the DPU using machine learning algorithms form the second key innovation of the device.

Physical sorting takes place in the asymmetric herringbone microfluidic-dielectrophoretic (FIG. 1, detail C1) or microfluidic-optoelectronic (FIG. 1, detail C2) structure. A laser activated single cell emits information, which is then processed by DPU using aforementioned methods, revealing its type. As the cell flows through the backbone channel of the structure, depending on its determined type, it is diverted to one of the branches. The diversion happens in one of two ways. In the microfluidic-dielectrophoretic scenario, underneath each branch there are two electrodes protruding up to the distal wall of the backbone channel. Once the electrodes are activated the electric field moves the cell into the side channel. In the microfluidic-optoelectronic scenario a laser is used to create a sloping /-shaped optical barrier inside the backbone channel, diverting the cell into the desired side channel.

Cells exit the side channels (FIG. 1, mark 2) into a unifying collection module C (FIG. 2. and FIG. 3). The collection module is flexible: it can contain a standard 98 well microplate, a smaller No of wells for high volume low variance collection, or higher No of wells for low volume high variance collection. If a cyclic process like directed evolution is being run, selected useful cells can be fed back into the reading-sorting module.

The device has four configurations. In the first (FIG. 2, A1 and A2) k+1 high pressure pumps with samples (k for cell and reagents—frequently two or three, and one for oil) are inserted to the left of the junction J. To the right of the junction, depending on throughput requirements, n microfluidic parallel integrated emulsion-incubation-sorting EIR modules are added. Finally, modules are united by the cell collector C. The second configuration (FIG. 2, B1 and B2) starts with the sample module. It is then powered by, depending on the throughput requirement, n low pressure integrated k+1 in 1 pumps. To each an integrated emulsion-incubation-sorting module is attached. Like in the first configuration, they are finally united by a collection module C. Third (FIG. 3, C1 and C2) and fourth (FIG. 3, D1 and D2) configurations are much like the first and the second, however, instead of a monolithic emulsion-incubation-sorting module, three discrete stand-alone ones are used.

In addition to high throughput and data quality commercial success also hinges on the use of a simple operational protocol. For this reason, in configurations A and B (FIG. 2) modules Eₙ, Iₙ and Rₙ are joined into a single operational EIRₙ module. This is not to deter advanced users, which have dedicated configurations C and D (FIG. 3), where the modules are separated, enabling a higher degree of individual customisation.

It is understood that the following claims are intended to cover all of the generic and specific features of the invention herein described and all statements of the scope of the invention which, as a matter of language, might be said to fall therebetween.

What is claimed:

1. Massively parallel rapid single cell reading and sorting device, characterised by four configurations, comprising pumping, microfluidic emulsification, incubation and reading-sorting modules.

2. Device as in claim 1, wherein the key property of said modules is internal and external parallelism.

3. Device as in claim 1, wherein the main material of said modules is either poly-dimethylsiloxane or the more robust borosilicate glass or quartz.

4. Device as in claim 1, wherein the said emulsification module encapsulates single cells into droplets and performs their fluorescent marking.

5. Device as in claim 1, wherein the said microfluidic-thermoelectric incubation module consists of serpentine channels and Peltier plates underneath.

6. Device as in claim 1, wherein the said reading-sorting module consists of: (i) continuous wave laser and single cell fluorescent genetic sequence sensor, (ii) titanium-sapphire pulsed laser and single cell visual-morphological information sensor, (iii) data processing unit, based on deep neural nets, classification and hierarchical and k-means clustering.

7. Device as in claim 1, wherein the said reading-sorting module uses cell type output information from (iii) inside (iv)—an asymmetric herringbone microfluidic-dielectrophoretic or microfluidic-optoelectronic construction, enabling multi-channel sorted cell output.

8. Massively parallel rapid single cell reading and sorting device is used for therapeutic antibody selection and engineering, cancer cell sorting, stem, progenitor and rare cell isolation, cell sorting according to genotype and phenotype, genotype-phenotype mapping, genomic library development and directed enzyme evolution.
